(19) United States
(12) Patent Application Publication
(10) Pub. No.: US 2002/0040373 A1
(43) Pub. Date: Apr. 4, 2002

(54) Integrated media management and processing system

(75) Inventors: Wolfgang Wichert, Bochum (DE); Marian Schuba, Bochum (DE); Bodo Hirtsiefer, Bochum (DE)

Correspondence Address: COLLARD & ROE, P.C., 1077 Northern Boulevard, Roslyn, NY, 11576, US

(73) Assignee: Boheads Cross Media GmbH

(21) Appl. No.: 09/823,779

(22) Filed: Mar. 30, 2001

(30) Foreign Application Priority Data
Oct. 4, 2000 (DE) 100 49 144.8

(51) Int. Cl. G06F 17/24; G06F 17/21

(52) U.S. Cl. 707/515; 707/501.1; 707/522

(57) ABSTRACT

The invention relates to a system for managing and processing digital media by means of an electronic data processing installation. The system consists of a data bank, in which digital media such as pictures, texts, charts, product data etc. are filed and managed in a standardized, neutral data bank format. The different digital media can be converted into the data bank format by means of suitable input and output filters. The media are managed in the data bank in the form of linked data objects. The linkages of the data objects define the layout of documents which can be output for publication purposes by means of suitable output routines in different output formats such as, for example Postscript and HTML.

### BACKGROUND OF THE INVENTION

1. Field of the Invention

The invention relates to a system for managing and processing digital media by means of electronic data processing equipment.

2. Prior art

The term “desktop publishing” (DTP) relates to the computer-supported generation, layout and management of publications of all types. Such publications may be, for example catalogues, advertising texts, brochures, magazine articles and other presentations. The publications are processed for printout in the form of paper in most cases. More recently however, the so-called web publishing is also finding an increasing use in conjunction with information that is made available on the Internet. Web publishing is the software-supported processing of presentations in the so-called hypertext format (e.g. XML) for display by means of a web browser.

In the computer-supported generation of product catalogues in the form of paper, or also for the Internet, it is necessary to combine a number of different media for the given presentation. This includes, among other things, production descriptions (also multilingual descriptions, if need be) in the form of text, data sheets in the tabulated form, photographs, drawings and other product and price information. This media is available on the computer in a great number of different formats because separate (or specific) processing tools are employed for processing each individual medium. These tools are word processing programs, chart calculation programs, drawing programs, picture processing programs, systems for managing merchandise, etc. Each of these programs uses data files that have their own, partially proprietary data formats, which are individually adapted to the given purpose of application.

DTP programs are employed in the generation of publications in which the various media mentioned above are assembled by hand. The individual elements such as texts, pictures, charts etc. are linked with each other with these programs in a layout. The different elements are selected in this connection, from the text, picture and chart programs filed in the computer system. Furthermore, additional graphical generation elements can be added to the document by means of the DTP program employed. The publication is subsequently available in a new, again proprietary format of the respective DTP program. DTP programs are capable of generating outputs for printers and composition machines. Tools for web publishing generate outputs that are directly suitable for making the presentation available on the Internet.

The methods described above for the computer-supported generation of publications are affected with a number of drawbacks. On the one hand, managing and assembling a great number of data files by hand is costly and time-consuming. The necessity of having to employ different tools for the various media leads to the fact that different data file formats have to be converted into one another during the course of generating publications, which is complicated, and quickly leads to the fact that a great number of data files are present in different formats, whose contents no longer can be allocated, or can only be assigned with difficulty. In addition, it is very troublesome to search in a targeted manner for specific contents that are present and distributed over a large number of individual data files. However, the principal drawback of the commonly employed method of desktop publishing comes to light when the publications are updated. When individual media that are combined in a publication are changed, much expenditure is required to determine where, or in which places the generated documents are affected by these changes. If several different publications contain the information that needs to be updated, the text, the picture or the chart has to be replaced by hand in each individual document in the correct place by substituting the new version of the respective medium. Even more time expenditure is required if the media are required in different documents in varying data file formats. In this case, the updated data files have to be made available first by converting them into the required formats, and subsequently incorporating them in the desired publication manually or semi-automatically. These drawbacks are particularly felt in conjunction with product-related publications such as catalogues, or in connection with web publications used for applications of e-commerce. The data of the merchandise management system that are to be included in the respective publications, are practically changing continually, and it is almost impossible to update the documents to be published accordingly with the methods of the desktop or web publishing described above.

### SUMMARY OF THE INVENTION

An object of the present invention is to provide a system for managing and processing digital media while avoiding the drawbacks specified above. This system combines the data input and data management, design and output in a centralized manner. At the same time, the goal of the invention is to provide a simple and at least partially automatic generation and updating of publications.

This problem is solved in conjunction with a system for managing and processing digital media of the type specified above by the combination of a data bank, in which the data objects are filed and managed in a medium-neutral data bank format, at least one program module for converting digital media into data objects in the medium-neutral data bank format, at least one program module for linking the data objects filed in the data bank to documents, as well as at least one other program module for outputting the documents in at least one output format.

All data relevant to the publication, which may be texts, pictures, charts or, data for managing merchandise or goods can be stored in the media-neutral data bank in a general, standardized format, and centrally managed and sorted according to any desired criteria. The manual management of a large number of separate data files in all sorts of different formats and also the conversion between the different formats are thus completely dispensed with. Commonly employed data bank architectures of the type that can be employed for the system as defined by the invention permit a distributed data maintenance and care. For example, multiple data acquisitions of data are avoided once such data have been acquired. Furthermore, rapid data access and the ability to have good searching of all relevant data are assured at the same time. The system as defined by the invention therefore can also be employed as a media archive, serving as a base for the efficient generation of publications.

The conversion of the media into the neutral format of the data bank takes place by means of suitable program modules, which are part of the system as defined by the invention. These filters permit the integration of information from merchandise management systems and/or data banks or other tools for generating and processing digital media that has already been structured.

Documents are defined with the system of the invention by virtue of linking the contents of the data bank. This linking for the purpose of obtaining comprehensive data objects may take place within the data bank. Modern, object-oriented data bank systems are accordingly particularly well suited for the application as defined by the invention. The layout of the documents is determined by the linking of the individual media. Additional design elements of the layout can be generated when the latter is produced, and added to the data structures of the respective document as well. The media-neutral data format comes to bear when the data objects are linked because different media (pictures, text, charts etc.) can also be combined in this way without any problem.

With the help of the system as defined by the invention, the updating of documents is particularly simple because the media being changed have to be input into the data bank only via the input filters specified above. All documents accessing the respective media are therefore directly updated. Therefore, it is no longer necessary in the updating process to access the individual documents. Changing the data objects used and filed in the data bank suffices in order to update all relevant documents at the same time.

The system as defined by the invention has a program module for outputting the generated documents. Outputs in different formats can be provided, for example, in order to be able to output the generated documents on printers and composition machines. Furthermore, for web publishing, an output in a suitable standard such as, for example XML should be possible. The fact that output modules are available at the same time for paper and electronic media is especially advantageous because different types of publication can be centrally managed and coordinated with each other in this way.

So that existing DTP systems can also be employed with the system of the invention, it is useful to provide a program module that extracts data objects from documents. This program module is capable of reading in different data formats of commonly used DTP programs, and therefore can automatically make available all existing layouts including the media used, and all other layout-relevant information, for managing and processing data according to the invention.

To automatically link media for the purpose of obtaining publications with pre-generated layouts, it is advantageous if the data objects filed in the data bank can be linked into the system of the invention in a rule-based manner. For example, publications can be generated in a fully automatic way if the layout can be fixed according to preset rules in conjunction with these publications, depending on the media contained in the latter. It is, therefore, useful to make provision for a rule-based program module, for example in the form of a programming language, wherein a corresponding set of rules can be applied to predetermined parts of the media stored in the data bank. This program module can be realized in the form of an adaptive method processor, by which individual objects from different input sources are combined to documents in a manner based on rules. Particularly many possibilities are obtained if the contents of the available media can be included in the rules employed by the method processor. This is possible without problems with the system of the invention because all data objects are present in a standardized and therefore transparent data bank format.

It is useful, furthermore, if provision is made in the system of the invention for a user interface to link the data filed in the data bank. This permits an individual generation of publications that has layout features similar to those to which the user is accustomed to conventional DTP systems. The arrangement of the available media for the given publication can be preset by means of the user interface. Provision can be made at the same time for editors, wherein objects such as texts, pictures and charts filed in the data bank are processed.

To output the documents processed as defined by the invention, languages for writing pages such as, for example Postscript are especially advantageous for controlling printers, and HTML for making publications available on the Internet.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a schematic representation of the architecture of a system as defined by the invention; and

FIG. 2 shows the principle on which the media-neutral data bank functions as defined by the invention.

### DETAILED DESCRIPTION OF THE PREFERRED EMBODIMENT

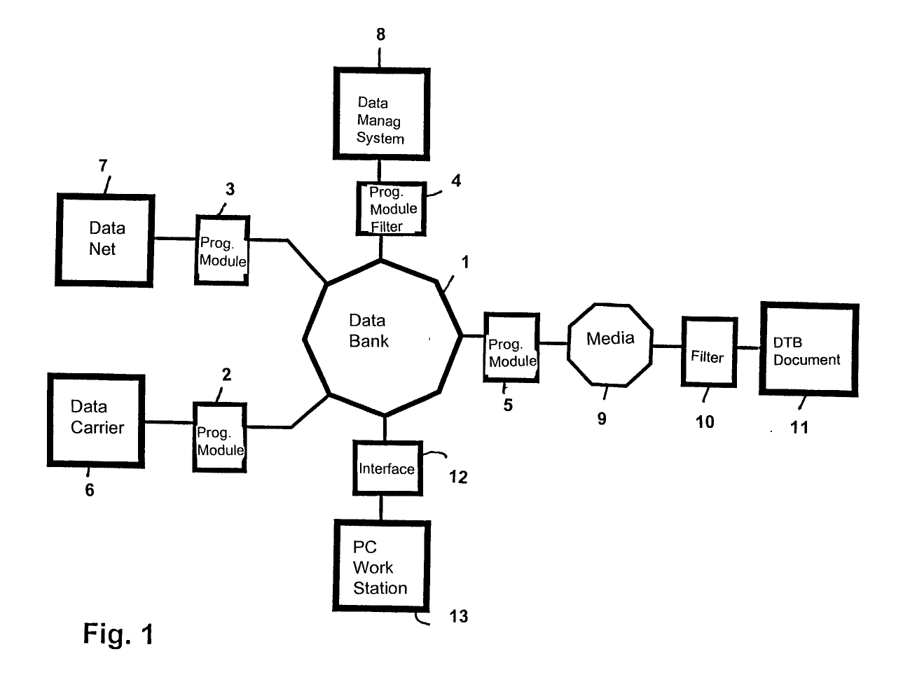

Referring now in detail to the drawings and, in particular, FIG. 1, there is shown the structure of a system for managing and processing digital media as defined by the invention. A data bank 1 is located in the center. All data objects such as, for example texts, pictures, charts or tables, product data etc. are stored in data bank 1 in a media-neutral memory. The data can be fed in or out via the suitable program modules 2, 3, 4 and 5. Module 2 reads in digital form, media from a data carrier such as, for example a CD-ROM 6. The module 3 is an input and output filter for HTML documents for communicating via a data net 7 (Internet). The data managed in a management system 8 for merchandise can be transmitted via a filter 4 to the data bank 1 and read out from this data bank. Filter 4 is capable in this conjunction of evaluating the structure in which the data are filed in merchandise management system 8. Module 5 serves to convert the media 9 such as, for example texts, pictures, charts etc., which may also be present in a structured form, linked with each other, to obtain data objects in the neutral data bank format. The contents of data bank 1 can be outputted at the same time in corresponding formats. An additional filter 10 reads out from a DTP document 11 the respective media 9. Filter 10 operates bi-directionally in this conjunction, i.e. it is possible also to generate by means of filter 10, DPT documents from media 9 that are generated from data bank 1 contents via module 5. An interface 12 permits the management and control of data bank 1 by means of a PC workstation 13. PC work station 13 can also be used at the same time to collate and process the media stored in data bank 1 into documents, using a suitable user interface.

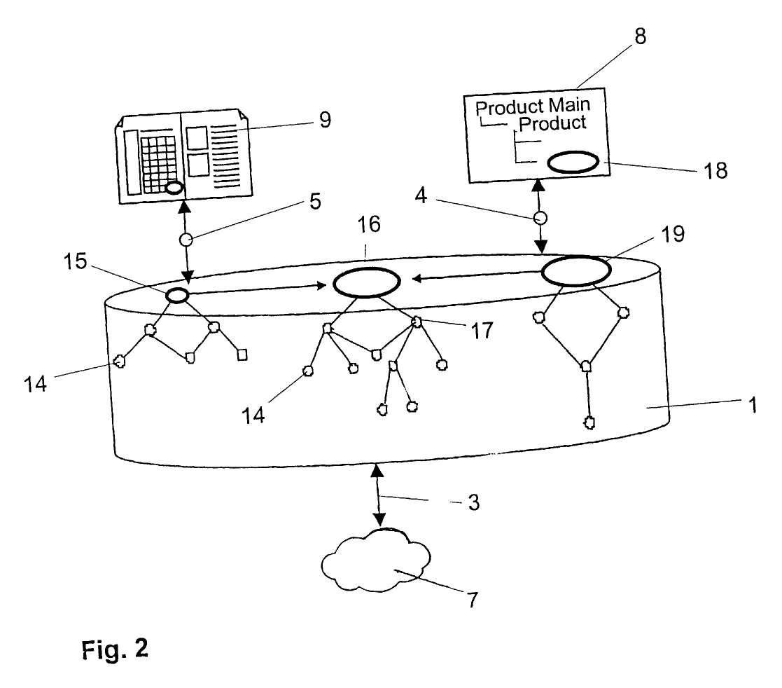

The media-neutral data bank 1 is also shown in FIG. 2. The document data 9 can be generated and read in by means of filter 5. Filter 5 is capable of recognizing and reading out the data contained in data set 9, as well as their linkage. A data object 15 is then generated based on the recognition and readout, which is stored in data bank 1. At the same time, filter 5 can be employed to generate a printable document 9, for example from a document 16 filed in data bank 1, wherein document 16 in turn consists of a plurality of data objects 17, which are linked with each other.

It is possible by means of program module 4 to transfer the structured data 18 from merchandise management system 8 to data bank 1. The data are stored as the data object 19 in data bank 1 as well.

Furthermore, it is possible according to the invention to link the various data objects 15 and 19 with each other to obtain a data object or document 16. The latter contains a series of the individual digital media 14 and 17 that define the layout of the document. Data bank 1 has an XML interface 3, via which the document can be made available on data net or Internet 7.

Accordingly, while only a few embodiments of the present invention have been shown and described, it is obvious that many changes and modifications may be made thereunto without departing from the spirit and scope of the invention.

What is claimed is:

1. A system for managing and processing digital media (9) by an electronic data processing installation, comprising:
a data bank (1), having data objects (14, 17) filed in a media-neutral data bank format;
at least one program module (5) for converting the digital media (9) into said data objects (14, 17) in the media-neutral data bank format;
at least one program module for linking said data objects (14, 17) filed in said data bank (1) to documents (16); and
at least one program module (3) for outputting the documents in at least one output format.

2. The system for managing and processing digital media according to claim 1, comprising a program module for extracting data objects from documents.

3. The system for managing and processing digital media according to claim 1, wherein said program module is rule-based for automatically linking data objects filed in said data bank into documents.

4. The system for managing and processing digital media according to claim 1, comprising a user interface for linking said data objects filed in said data bank.

5. The system for managing and processing digital media according to claim 1, wherein the documents can be output in a page written language.
